(19) United States
(12) Patent Application Publication
(10) Pub. No.: US 2026/0084506 A1
(43) Pub. Date: Mar. 26, 2026

(54) PROTECTIVE COVER APPLICABLE TO A VEHICLE ROOF

(71) Applicant: Christian Ariel Sabas, Mendoza (AR)

(72) Inventor: Christian Ariel Sabas, Mendoza (AR)

(21) Appl. No.: 19/338,420

(22) Filed: Sep. 24, 2025

(30) Foreign Application Priority Data
Sep. 24, 2024 (AR) 20240102565

(51) Int. Cl. B60J 11/04

(52) U.S. Cl. CPC B60J 11/04

(57) ABSTRACT

A cover is mounted on a vehicle's luggage rack and acts as a protective resource against all types of weather conditions. The cover has a mounting structure with a preferably square base, which is secured to the luggage rack. A laminar cover is arranged on the base, mounted on a plurality of stiffening rods that form part of the mounting structure, each of which is secured to the edges of said base by means of hinges. Each hinge allows its respective associated stiffening rod to be arranged extended over the base keeping the cover folded, or by rotating 180°, projected outwards from the same base, keeping the cover deployed, elevated and cantilevered extended over a substantially horizontal plane, above the vehicle's roof.

### CLAIM OF PRIORITY

This application claims priority to Argentinian Patent Application no. AR 20240102565 filed on Sep. 24, 2024, the entirety of which is hereby incorporated by reference.

### BACKGROUND OF THE DISCLOSURE

The present disclosure has as its main objective a protective cover applicable to a car or vehicle roof, specifically designed to act as a protective resource against all types of weather contingencies, such as rain, snow, hail, and wind, as well as to withstand the rigors of sun, frost, and any kind of dirt that may fall on the vehicle.

Currently, there are several devices to protect cars from the sun, rain, and hail, such as covers, car covers, inflatable covers, foldable PVC fabric tents, and automatic folding sunshades, all of which have some inconvenience both in their use and purpose.

In general, it is possible to identify several disadvantages, such as delays in the complete assembly time of the device. This can result in not being able to fully protect the car. Also, most protective devices are stored in the vehicle's trunk. This means a person has to go to the trunk, take out the device, place it, and only then start assembling it, which wastes a lot of time. In the event that hail begins to fall, the device will not be able to adequately protect the car.

Most covers are very inconvenient to transport due to their size because they have a lot of volume, especially in the case of car covers.

Most of the existing protective devices are not practical, effective, or easy to disassemble and store. That is, a user would have to take too long to disassemble and store them. For example, if it has rained or hailed, the covers remain wet and have debris like leaves and dirt. This causes a person to have to re-assemble the device, wash it, and wait for it to dry because if not, it can be ruined. Although they are waterproof, there are PVC or PE (polyethylene) tarps that are ruined if stored while damp, as they can rot and produce unpleasant odors.

Regarding covers that are assembled on the surface of the vehicle, touching the paint, plastics, and metal of the vehicle, causes the paint to be scratched even if they have soft anti-friction fabrics, because the surface of cars is never completely clean; they have dust, bird droppings, etc., on the outer surface from being outdoors. When some devices are dismantled, whether they are inflatable covers or protectors, they can get caught on different points of the vehicle's body and cause broken plastics and even dents in the vehicles body if there is wind.

When wind blows, or hail and wind occurs, it is difficult to cover the vehicle with inflatable or non-inflatable covers and also to place the umbrella-type ones with suction cups on the roof. It is almost impossible for a single person to install the cover and can even be dangerous depending on the wind speed.

Referring to the umbrella device with suction cups on the vehicle's roof, they do not withstand wind when it is a little strong (such as greater than a speed of 40 km/h) since the tie-downs they have (such as on the side mirrors and door handles of the vehicles) can break, because they were not designed for that purpose. In addition, the suction cups on the roof tend to detach due to the force of the wind. When hail falls, the temperature drops, and this also causes the suction cups to tend to detach from the car's roof and stops fulfilling the function of protecting the car from hail.

As for non-inflatable covers or protectors, one must consider the size, the amount of hail that falls, and the wind speed, because there are covers that cannot withstand hail impacts, and the vehicle ends up being damaged.

Regarding inflatable covers or protectors, their disadvantage is that it takes time to fully inflate the cover, not to mention that the device could have a malfunction, such as the battery running out, the inflation motor failing due to the car's 12-volt charger, or worse still, if it uses 220-volt current and a power outage during a storm prevents it from inflating the cover and fulfilling its function of protecting the vehicle.

It is also worth noting that in most cases, inflatable covers or protectors, non-inflatable ones, and automatic folding sunshades sometimes do not cover the entire vehicle and therefore do not protect the vehicle completely. Some of the ends are left exposed, as is often the case on the sides.

More specifically, the present disclosure refers to a protective cover created to be placed folded on the luggage rack that goes on the car roof, arranged on it to be used and opened quickly when needed. A person can simply get out of the car and deploy it easily and quickly, so that, in less than two minutes, it is properly unfolded, extended over the vehicle's roof, and secured to the luggage rack.

There is a need for an improved protective cover for a car roof which overcomes the above mentioned deficiencies and others of existing protective covers while providing better overall results.

### SUMMARY OF THE DISCLOSURE

Various details of the present disclosure are hereinafter summarized to provide a basic understanding. This summary is not an extensive overview of the disclosure and is neither intended to identify certain elements of the disclosure, nor to delineate scope thereof. Rather, the primary purpose of this summary is to present some concepts of the disclosure in a simplified form prior to the more detailed description that is presented hereinafter.

The present disclosure is directed to a portable cover that, for its use, is linked to the vehicle's luggage rack, for its transport and storage. It is practical since it has an optimal size and does not take up excess space in the trunk or boot.

The disclosure contemplates that the cover, when properly folded, can be stored over the luggage rack, in which case it is not required to be moved to the trunk for storage. The cover that contains the protective cover will be made of a special fabric that repels the formation of fungi, such as those used to cover boats that are on the sea or rivers. This would help in the case of rain or hail, which would cause debris such as leaves and dirt to remain on the cover. Even if a person had to store it wet, it would resist humidity due to the characteristics of the fabric and would not be susceptible to rot like PVC or PE tarps, nor would it produce an unpleasant odor. Washing the cover is easy and convenient since the fabric is waterproof and quick-drying; by just spraying it with clean water and shaking the cover, it can be stored again and be ready for re-use quickly.

When the cover is contained in a bag that extends over the car roof, such as secured to the bars of the luggage rack, when the cover is unfolded, it projects or extends over the roof, in a cantilevered manner, without touching the roof. That is, it does not touch the paint, plastics, or metal of the car, which eliminates the possibility of such as damage such as scratches to the paint or when the wind blows.

In accordance with one aspect of the disclosure, the cover, when properly unfolded, is compact and aerodynamic, and its size makes its transport very convenient. Its placement on the luggage rack bars is very easy, extremely fast, and simple, even in windy conditions.

In accordance with another aspect of the disclosure, the cover can be used every day of the year, for example, in summer when the sun is very strong or in rainy conditions, when there is a possibility of hail or in winter when there is frost or snow.

In accordance with another aspect of the disclosure, the materials the cover is made of are of excellent quality and durability, which makes it very resistant to weather contingencies such as rain, snow, hail, and/or wind. The canvas used in covers construction has the latest technology used in the naval industry that protects boats.

Another aspect of the disclosure is the protective cover of the present disclosure is built on a mounting structure that is formed on a preferably a square base which is secured to the vehicle's luggage rack using conventional clamps. On the base, there is a laminar cover, preferably made of marine-grade canvas, which is mounted on a plurality of stiffening rods that form part of the mounting structure. These rods are secured to the edges of the base by hinges that allow each of them to fold back with a rotation of up to 180°.

The laminar cover, secured to the aforementioned stiffening rods, gives shape to the cover of the disclosure, so that when all of the rods are folded back onto the base, the cover is in a retracted position. When the same stiffening rods are rotated 180°, the cover is deployed and projects outward, remaining elevated and cantilevered above the roof level, thereby covering a larger surface area than the one determined by the upper plane of the vehicle it protects.

In accordance with another aspect of the disclosure, the cover can be contained within a rectangular box with an aerodynamic shape made of fiberglass, which has a base on which the aforementioned stiffening rods are placed, which support the said marine-grade canvas that will cover the entire vehicle to protect it from any weather contingency.

In accordance with another aspect of the disclosure, stiffening rods can be fiberglass tubes of three different sizes and diameters. Each of the tubes is inserted into metal hinges welded to the edges of the base, which allow a 180° movement. The fiberglass tubes are lightweight and very resistant to impact and forces that can act on them due to wind. They can withstand heat and UV rays very well, as well as low temperatures, and are not current transmitters in the event of electrical storms.

In accordance with another aspect of the disclosure, stiffening rods of greater length and a telescopic configuration are used in the front part; each one extends from a respective hinge to protect different front sections of the car, one extends to the right, another extends to the left, and another extends to the center.

Likewise, in the rear part, three stiffening rods can be located, of a shorter length than the previous ones, which also extend from respective hinges.

In accordance with still another aspect of the disclosure, a marine-grade canvas of German origin called Techtex-Filatex is secured to the aforementioned stiffening rods, which is sewn over a large part of each of the rods. The fully extended or deployed protector covers the entire vehicle without touching it, and its preferred dimensions can be 5.20 meters long by 4.20 meters wide, while when folded for storage, it can be 1.55 meters long, by 1.10 meters wide, and with a thickness of approximately 10 cm.

Still other aspects for the disclosure will become apparent upon a reading and understanding of the following detailed description.

### BRIEF DESCRIPTION OF THE DRAWINGS

The following is a brief description of the drawings, which are presented for the purposes of illustrating the exemplary embodiments disclosed herein and not for the purposes of limiting the same.

FIG. 1 is a front perspective view showing the cover, in its position of use, on a conventional vehicle;

FIG. 2 is a rear perspective view showing the cover of FIG. 1;

FIG. 3 is a side elevational view showing the front cover housed in a containment bag that is secured to the vehicle's luggage rack;

FIG. 4 is a top elevational view showing the mounting structure used to form the cover of FIG. 1;

FIG. 5 is a front perspective view of the cover deployed and projected upward, before being placed in to the position of use;

FIG. 6 is a front perspective view showing the cover's tie-down arranged in the front part of the vehicle;

FIG. 7 is a front perspective view of the cover's tie-down arranged in the rear part of the vehicle;

FIG. 8 is a enlarged side elevational view of the cover's tie-down on one of the rear sides of the vehicle that is being protected;

FIG. 9 is an enlarged front elevational view showing for the cover's tie-down in the front part of the vehicle;

FIG. 10 is a side elevational view of the tie-down of the cover on a lateral side of the vehicle; and

FIG. 11 is a side elevational view of a tie-down for securing the cover to a vehicle seat.

### DETAILED DESCRIPTION OF THE DISCLOSURE

A more complete understanding of the components, processes and apparatuses disclosed herein can be obtained by reference to the accompanying drawings. These figures are merely schematic representations based on convenience and the ease of demonstrating the present disclosure, and are, therefore, not intended to indicate relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawings and are not intended to define or limit the scope of the disclosure. In the drawings and the following description below, it is to be understood that like numeric designations refer to components of like function.

The singular forms “a,” “an,” and “the” include plural referents unless the context clearly dictates otherwise.

As used herein, the terms about, generally and substantially are intended to encompass structural or numerical modifications which do not significantly affect purpose of the element or number modified by such term.

As used herein, the recitation of numerical ranges by endpoints includes all numbers subsumed within that range (e.g. 1 to 5 includes 1, 1.5, 2, 2.75, 3, 3.6, 4 and 5 and the like). Similarly, where multiple ranges are set forth with respect to an item, it is intended that the ranges reflect the various combinations thereof (e.g. 1 to 5 or 2 to 3 also includes the ranges 1 to 3 and 2 to 5, and the like).

As used in the specification and in the claims, the term “comprising” may include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated or process as “consisting of” and “consisting essentially of” the enumerated ingredients/steps, which allows the presence of only the named ingredients/steps, along with any impurities that might result therefrom, and excludes other ingredients/steps.

It is clarified that, in all figures, the same or equivalent parts or constituent elements of the assembly correspond to the same reference numbers and letters, according to the example chosen for the present disclosure of the cover.

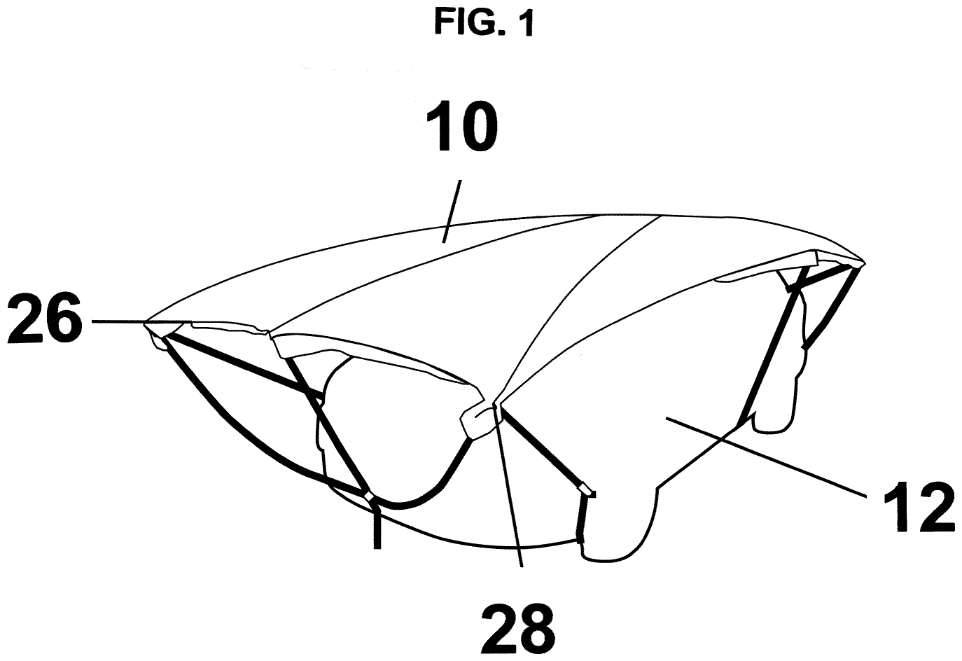

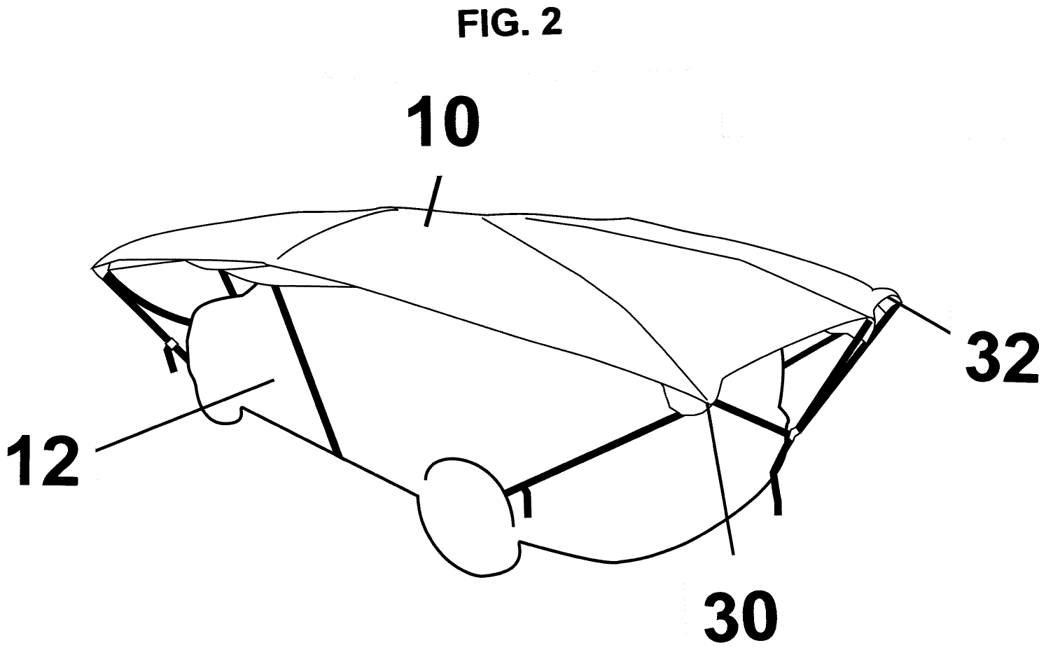

Referring to FIGS. 1 and 2, the protective cover 10 of the present disclosure, has been designed to be extended over the roof of a vehicle or car 12, protecting it from the inclement weather and the elements.

The cover 10 is preferably a laminar cover that extends over a substantially horizontal plane defined above the car, without making contact with the car roof. It is kept secured to the car through tapes or straps that extend from certain points on the edge of said laminar cover, to be secured at specific chosen anchor points on the vehicle.

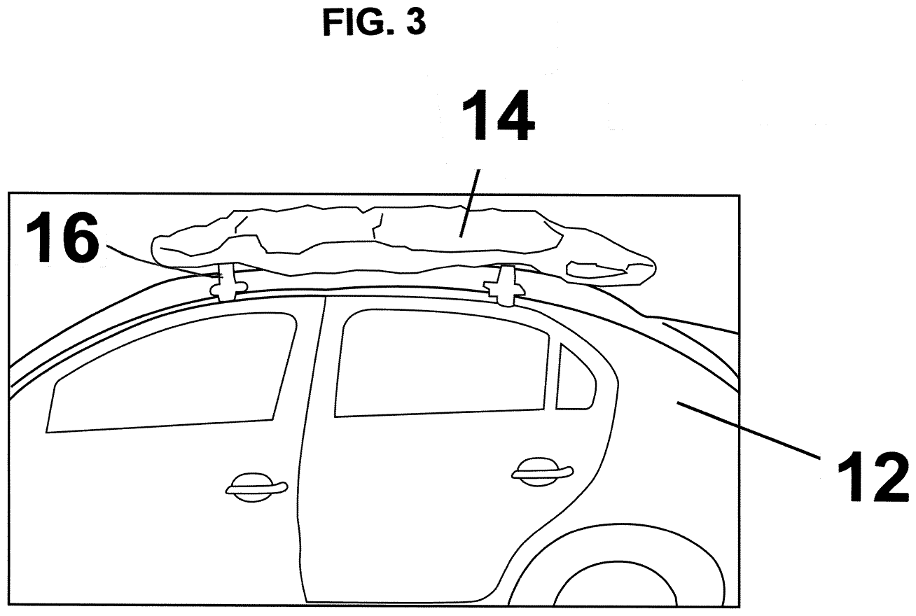

FIG. 3 shows that the cover can be placed inside a case or bag 14 that is mounted and secured to the luggage rack 16 of the car or vehicle 12. The bag will be made of a material suitable for being outdoors and includes a zipper through which it is opened on three of its border sides to allow the cover, which remains housed inside, to be removed and deployed.

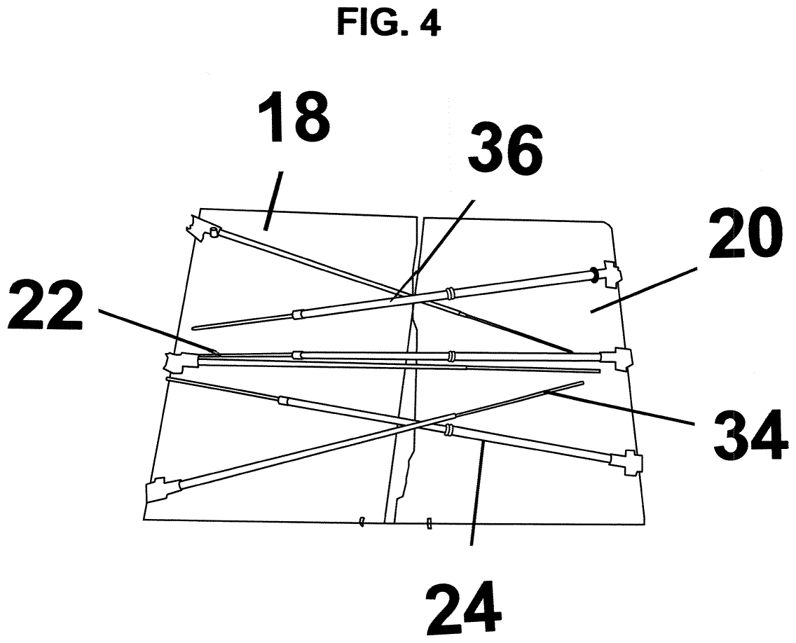

Referring now to FIG. 4, the cover includes a mounting assembly 18 which, in the preferred embodiment, may have longitudinal metallic arms 24, 34, 36, on which a preferably square base 20 is defined. The base can be secured to the luggage rack by adjustable clamps (not illustrated).

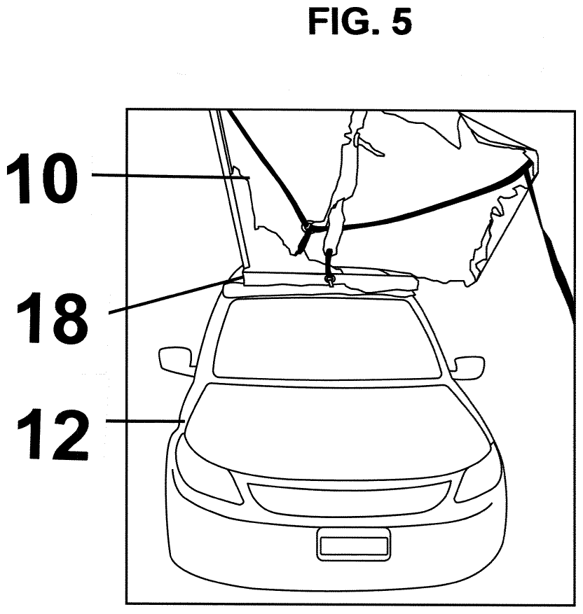

As can be seen in FIG. 5, the laminar cover 10 is mounted on mounting assembly 18 and a set of stiffening rods that are arranged in the mounting assembly, through which it can be deployed to be in the position of use, or folded for storage.

Referring again to FIG. 4, each of the stiffening rods 22, 34, 36 is secured to the base 20 of this mounting structure by means of a respective hinge 22, so that it can rotate from 0° in a rest position, extended over the said base 20, to projecting outwards with a 180° rotation.

The use of longer telescopic rods 24 can be employed, whose free ends are secured at the front and rear vertices of the laminar cover 10, giving definitive shape to the cover.

FIGS. 1 and 2 show how the front vertices 26, 28 of the cover are formed, as well as the rear vertices 30, 32 of the cover.

Referring to FIG. 4, the use of non-telescopic stiffening rods 34 may also be used, as well as stiffening rods 36 intended to extend from a lateral edge of the base 20, so that, when folded back 180°, their free ends remain secured at an intermediate point on the edge of the cover.

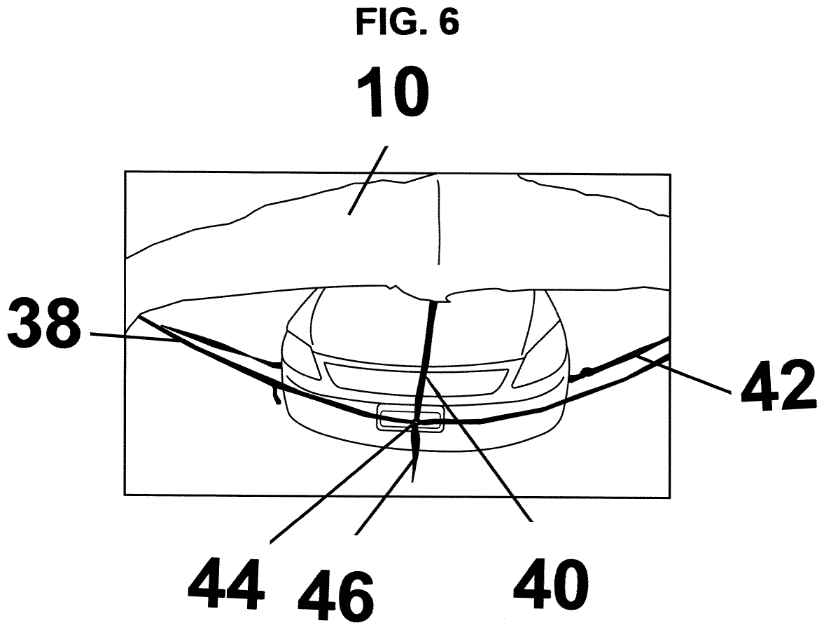

Referring to FIGS. 6-11, to ensure that the cover remains properly deployed and extended in a horizontal plane, above the roof level of the vehicle, a tie-down system using backpacker straps is employed and is now discussed.

FIG. 6 shows a set of front backpacker straps 38, 40, 42 that extend from front edge points of the cover towards a core, which could be an eyelet 44 from where a section 46 extends to be secured to the vehicle's chassis in its lower front section.

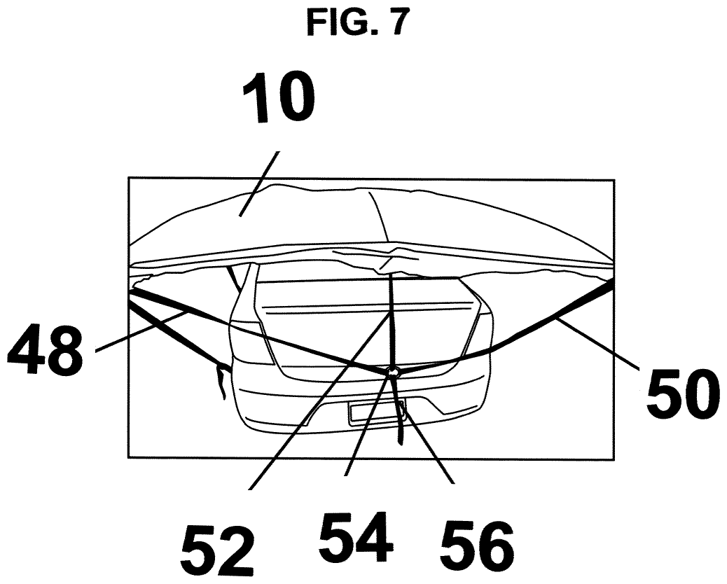

Likewise, FIG. 7 shows a set of rear backpacker straps 48, 50, 52 that extend from rear edge points of the cover towards a core, which could be an eyelet 54 from where a section 56 extends to be secured to the vehicle's chassis in its lower rear section.

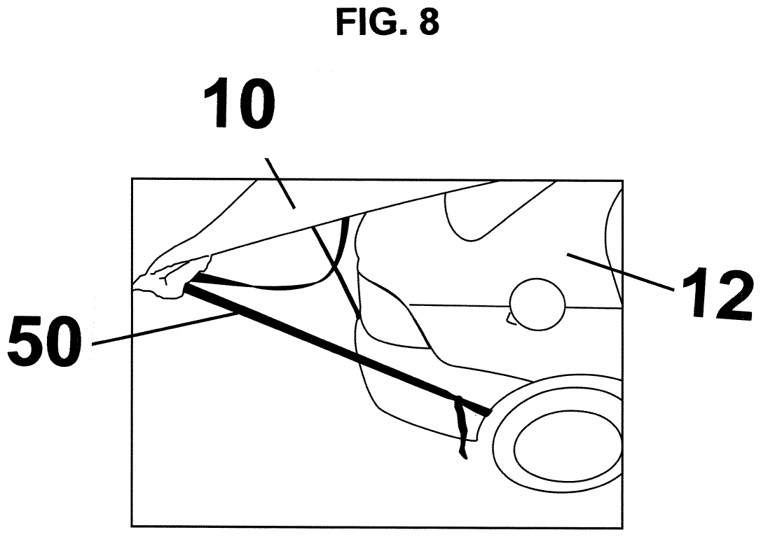

Referring to FIG. 8, it is illustrated how the backpacker strap 50 is tied down on a rear side of the vehicle's body.

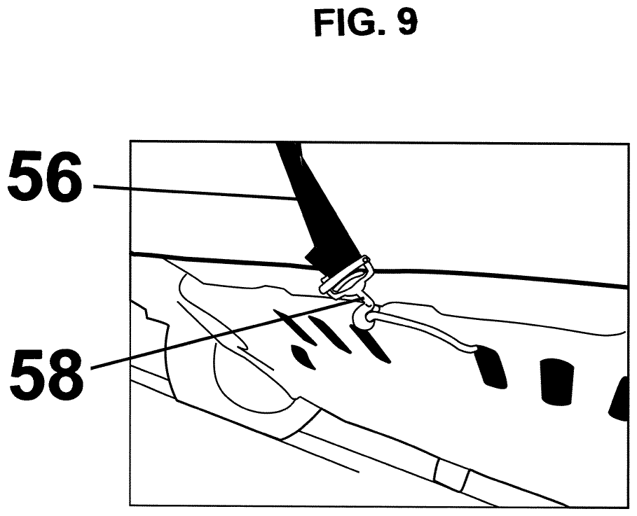

FIG. 9 shows that the aforementioned section 56 of backpacker strap is tied to the chassis using a fitting such as a keychain carabiner 58, through which it is possible to mount and remove the tie-down simply and quickly.

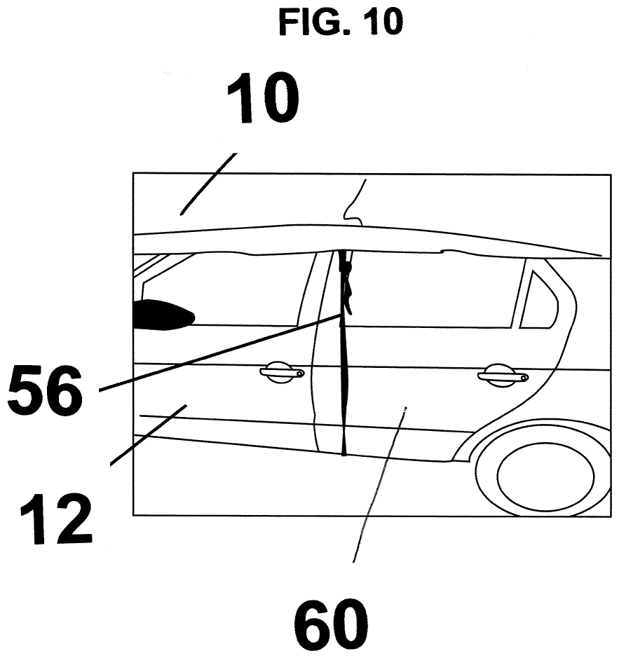

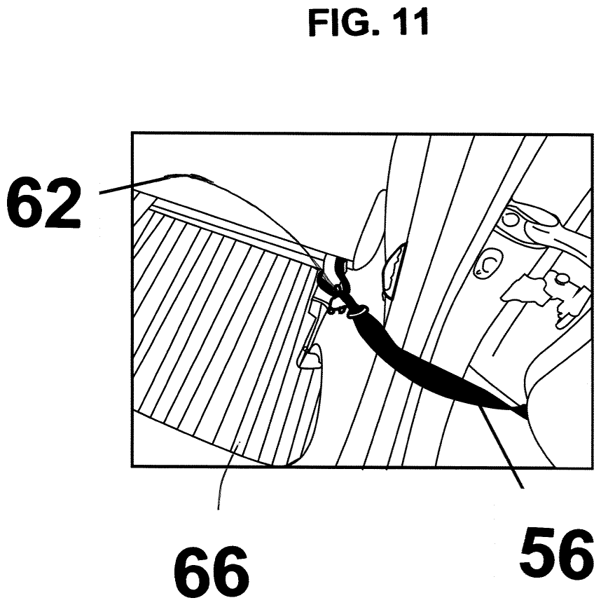

Referring now to FIGS. 10 and 11, it is seen that, for the mounting of the cover 10, the use of backpacker straps 56 is also employed. These straps extend from a lateral edge of the cover, to enter the interior of the vehicle and be secured in correspondence with one of the seat benches 66 of the vehicle.

Specifically, FIGS. 10 and 11 show the section of backpacker strap 56 that passes through the door 60 so that, using the keychain carabiner 62, it is secured to the steel cable that is under the seat 66.

Referring back to FIGS. 1, 2, 4 it is possible to appreciate the longer stiffening rods 34, which may be made of fiberglass, as well as the shorter rods 36 where one rod is mounted on the driver's side and the other rod is mounted on the passenger's side of the vehicle.

It is also noted that, at the tip of each of the rods 34, 36, a galvanized steel “fischer” stud may be placed, while for the aforementioned mounting tie-downs, in preferred embodiments, a reinforced backpacker strap (about 4 cm wide) will be used.

The backpacker straps, at their tie-down end, can be secured to a fitting such as a chromed brass swivel keychain carabiner, which is attached to a vehicle seat, for which a covered steel cable can be used for the tie-down, secured with cable press clamps.

Referring back to FIG. 2, stiffening rods 24 that extend covering the rear part of the cover, so that the different areas of the rear part of the vehicle are effectively covered. One rod covers the left part, one rod covers the right part, and another rod covers the central area of the car. At the tip of each of the rods 24, a corresponding galvanized steel “fischer” stud will be placed.

Specifically, it can be said that the aforementioned mounting structure uses three types of stiffening rods 24, 34, 36 placed in the front, in the central section, and in the rear part of the cover. Each one, when deployed, ensures that the protector covers different areas of the front part, the left side, the right side, and the center of the car.

It is also noted that, in preferred embodiments, a respective reinforced backpacker strap (4 cm wide), properly sewn to a “fischer” stud, extends from each of said rods 24, 34, 36. Each strap extends so that, at its free end, a chromed brass swivel keychain carabiner is sewn, which can be secured to the underside of the car or to a seat.

In a preferred embodiment, the laminar cover may be fabricated of a “Techtex”-“Filatex” brand canvas of German origin, distinguished by having an internal layer that completely prevents the passage of light and has thermal insulation capacity, combined with an external layer that is airtight, waterproof, refractory with UV ray protection, highly durable, easy to wash, and very lightweight.

An advantage of the cover of this disclosure is that it protects the car from all weather contingencies such as rain, snow, hail, and wind, and also from the sun, frost, and any kind of dirt that may fall on the cover. The cover is completely portable and covers the car without touching the car; it is only supported on the luggage rack bars of any type or brand that are placed on the car's roof.

By being permanently placed on the car's roof, the cover is always ready to be used and opened quickly with a very simple, practical, and fast process of assembly, disassembly, and storage.

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. A protective cover applicable to a vehicle roof, mounted on a vehicle's luggage rack and acting as a protective resource against all types of weather contingencies, comprising a mounting structure that is formed on a substantially square base which is secured to the luggage rack, on which a laminar cover is arranged, mounted on a plurality of stiffening rods that form part of said mounting structure, each of which is secured to the edges of said base by means of hinges.

2. The cover of claim 1, wherein each hinge allows its respective associated stiffening rod to be arranged extended over the base, keeping the cover folded.

3. The cover of claim 1, wherein each hinge allows its respective stiffening rod to be arranged by rotating 180°, projected outwards from the base, keeping the cover deployed, elevated and cantilevered extended over a substantially horizontal plane, above the vehicle's roof.

4. The cover of claim 1, wherein the laminar cover and its mounting structure are secured to the luggage rack by means of adjustable clamps.

5. The cover of claim 1, wherein the laminar cover mounted on the plurality of stiffening rods is a marine-grade canvas.

6. The cover of claim 1, wherein the stiffening rods are telescopic rods.

7. The cover of claim 1, wherein backpacker straps extend from the edges of the laminar cover, originating from the free ends of each stiffening rod, and extend to be tied down on a lower lateral side of the vehicle's body.

8. The cover of claim 1, wherein front backpacker straps extend from an edge of the laminar cover, which converge on an eyelet from which a section originates and extends to be secured to the vehicle's chassis in its lower front section.

9. The cover of claim 1, wherein rear backpacker straps extend from an edge of the laminar cover, which converge on an eyelet from which a section originates and extends to be secured to the vehicle's chassis in its lower rear section.
